(19) United States
(12) Patent Application Publication
(10) Pub. No.: US 2003/0224078 A1
(43) Pub. Date: Dec. 4, 2003

(54) Extrusion head

(76) Inventor: Walter J. McGuire, Swedesboro, NJ (US)

Correspondence Address: Patent Counsel, Huntsman Polyurethanes, 286 Mantua Grove Road, West Deptford, NJ, 08066-1732, US

(21) Appl. No.: 10/396,169

(22) Filed: Mar. 25, 2003

Related U.S. Application Data
(63) Continuation of application No. PCT/US01/30008, filed on Sep. 26, 2001.

(51) Int. Cl. B29C 47/02

(52) U.S. Cl. 425/113

(57) ABSTRACT

Extruder head adapted for receiving and distributing extruded materials comprises a rear wall defining a discharge port; substantially parallel upper and lower walls, wherein each of said upper and lower walls has a longitudinal axis which runs parallel to said rear wall, and are interconnected by said rear wall to define an open channel therebetween; wherein at least one of said upper or lower walls defines a transverse, recessed trough aligned with said discharge port for distributing material discharged from said port; wherein said open channel is adapted to receive a substrate to which extrusion material is applied when said substrate is passed through said channel.

### CROSS REFERENCE TO RELATED APPLICATIONS

This application is a continuation of international application PCT/US01/30008, filed Sep. 26, 2001, and claims priority to U.S. Provisional Application Serial No. 60/234,956, which was filed on Sep. 26, 2000.

### TECHNICAL FIELD

The invention relates to an extruder head for applying and distributing extruded material to a substrate. More particularly, the invention relates to an extruder head for applying adhesive to the edge, and a portion of either top or bottom surfaces of a substrate or both.

### BACKGROUND ART

Extrusion apparatus are well known in the plastics and adhesive industries. Over time, a number of extrusion devices and heads have been developed for specific uses. For example, different extrusion heads and dies have been developed specifically for extruding plastic tubing and monofilament. The extrusion head is specifically designed with the final desired properties in mind. For example, the combination of extrusion heads and dies determines the final wall thickness, and overall properties of a length of extruded plastic tubing.

Extruders have also been used for producing polyurethane and other foamed materials, where extrusion heads have been designed with particular final characteristics in mind, such as application thickness or density. Extrusion apparatus have also been used in applying layers of adhesive coatings to substrates. The present invention relates to an extrusion head useful for applying adhesive to a substrate.

In particular, the edge portion of a substantially planar substrate is often the subject of glueing operations. This area is often used when joining planar materials end to end, as in tongue-and-groove type arrangements. Adhesive, to be effective, must be applied to the outer edge, and in most instances a portion of the upper and lower surfaces of the substrate adjacent to the edge portion. In this manner, all surfaces which are inserted into the groove portion are coated with adhesive.

Although there are many applications that use tongue-and-groove type arrangements, of particular interest is the formation of wood product I-beams, which have been in favor for a number of years because of their combined strength and light weight characteristics. Typically, lengths of I-beam material are produced in standard lengths of repeating four or eight foot sections. For strength, the joints for the cross-bars are staggered from the joints of the interconnecting material. The interconnecting material is often referred to as the web. The web comes in approximately eight foot lengths and heights typically of 9-14 inches, although any size may be used. The upper and lower edges are adapted for attachment to the respective cross-bars, usually with a tongue and groove arrangement. Opposed ends of the web are provided with either a tongue or a mating groove, so that multiple webs may be interconnected to attain a desired length. It is primarily this connection that is crucial in maintaining the strength of the I-beam.

According to current methods, adhesive is applied to the tongue portion of the web prior to insertion into the corresponding groove. Adhesives, to date, are applied manually with a brush or roller dipped in an adhesive solution. The use of such manual techniques is messy and inefficient, and is not possible with some of today's preferred adhesives.

Previous adhesives, with relatively long cure times, could be applied by brush or roller without fear of unwanted curing. An open container of previous adhesives could possibly last for an entire work shift or longer without curing wastefully in the container. A worker easily dipped his brush or roller, as needed in the open supply of adhesive, without concern of substantial unwanted curing. Adhesives in use and being developed today, however, have much quicker curing rates.

In fact, the preferred adhesive used by the inventor is a single component, quick curing, cold-curing, isocyanate based adhesive that cures in a matter of minutes. Because of the nature of this and other newer adhesives it is no longer possible or desirable to use an open container of adhesive or even manual application means. The new adhesives must be applied quickly and cleanly to have the most effective and efficient application.

Accordingly, extrusion systems for the adhesives have been developed. The extrusion method allows for the adhesive to be held in a reactant free environment until it is applied to the substrate. Extrusion heads designed specifically to apply the adhesive to the desired surfaces of the substrate are needed for specific applications, such as tongue and groove joints, and specifically, for use in I-beam construction.

The present invention is an extrusion head designed with the specific needs of edge and surface application in mind.

### DISCLOSURE OF INVENTION

An extruder head adapted for receiving and distributing extruded materials comprises a rear wall defining a discharge port; substantially parallel upper and lower walls, wherein each of said upper and lower walls has a longitudinal axis which runs parallel to said rear wall, and are interconnected by said rear wall to define an open channel therebetween; wherein at least one of said upper or lower walls defines a transverse, recessed trough aligned with said discharge port for distributing material discharged from said port; wherein said open channel is adapted to receive a substrate to which extrusion material is applied when said substrate is passed through said channel.

### BRIEF DESCRIPTION OF THE DRAWINGS

FIG. 1 is a partial cut-away perspective view of an extruder head according to the invention.

FIG. 2 is a cross-sectional view taken along lines 2-2 of FIG. 1.

FIG. 3 is a partial front elevational view of the extruder head according to the invention.

FIG. 4 is an exploded cross-sectional view of an alternative embodiment of an extruder head according to the invention.

### BEST MODES FOR CARRYING OUT THE INVENTION

The extruder head 10 according to the invention is especially useful in applying adhesive to the edge portion of a substantially planar substrate 100, as discussed above in relation to the tongue of an interconnecting web used in forming wood product I-beams. However, the invention may be used in a myriad of other situations, as will be readily apparent to those skilled in the art. Accordingly, although the invention is discussed herein with reference to the preferred use in applying quick cure adhesive to the edge and surface portions near the edge of a planar substrate, particularly an a wood product web, the invention is not limited to this use alone.

The extruder head 10 is adapted for in-line connection to an extruder which supplies a fluid stream of adhesive or other extrusion material. The extruder head 10 comprises a rear wall 20, having a discharge port 22, an upper wall 30, and a lower wall 40, which together define an open channel. Each portion plays a different role in the even application of extruded adhesive materials to the substrate 100, as it passes through the open channel.

The upper and lower wall portions 30, 40 are arranged and held substantially parallel to each other, with the rear wall 20 interconnecting them along a longitudinal portion. The channel defined by the rear, upper and lower walls is open at opposed ends, and at a longitudinal side opposite the rear wall 20. The distance between the upper and lower walls 30, 40 is predetermined to accommodate a preselected thickness according to the substrate 100 to be treated. Typically, the web is ⅜ inch thick, although substrates of any thickness may be used.

The rear wall 20 is provided with at least one discharge port 22 in fluid communication with the extrusion device. In a preferred embodiment, the rear wall 20 houses a discharge manifold 24 for distributing extruded material to a plurality of discharge ports 22 in the channel-facing surface 26 thereof. Extruded material flows out of the ports 22 into the open channel defined by the rear, upper, and lower walls, and ultimately contacts the substrate 100. In this manner, the channel-facing surface 26 of the rear wall 20 is used to apply extruded material to the outer edge 112 of the substrate.

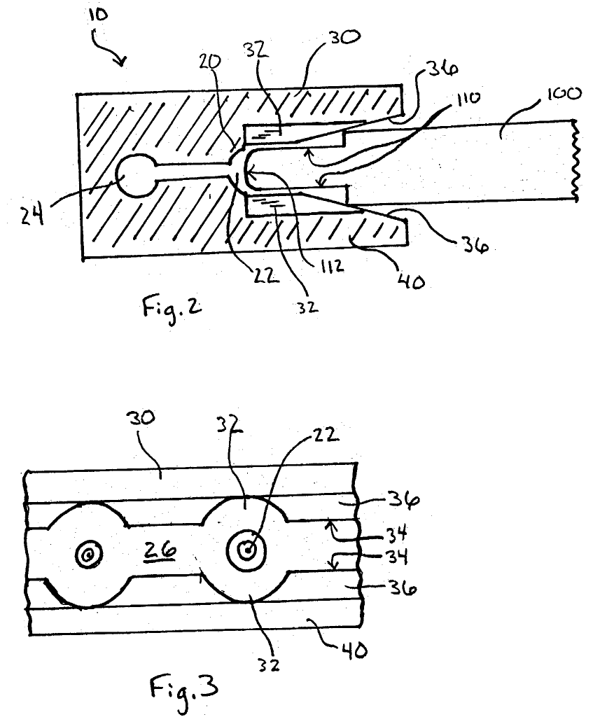

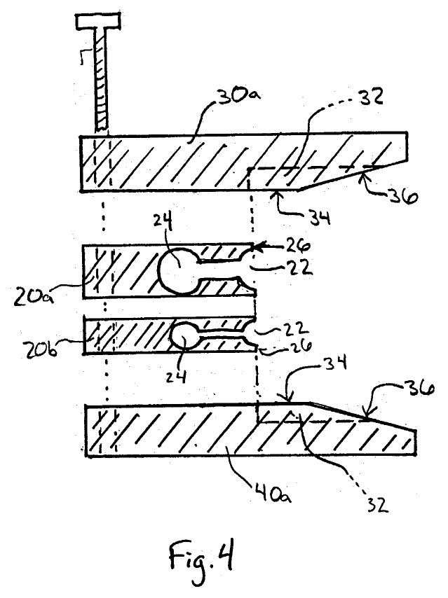

The upper and lower walls 30, 40 are used to apply extruded material to a planar portion 110 of the substrate adjacent the edge. Material flow to either or both of these surfaces may be controlled by the design of the upper and lower walls 30, 40. To control flow, at least one of the upper and lower walls 30, 40 is provided with a recessed trough 32 corresponding to and aligned with each discharge port 22. As seen if FIG. 2, extruded material exits the discharge port 22, and is forced around the edge 112 of the substrate 100 (thereby coating the edge itself) into the recessed trough 32 where it is distributed to the planar surfaces(s) 110 of the substrate. FIG. 2 illustrates the case where both the upper and lower walls are provided with complementary recessed troughs. This embodiment allows for simultaneous coating of the edge, and top and bottom surfaces of the substrate, without the need for multiple application steps.

In the preferred embodiment, illustrated throughout the figures, the upper and lower walls 30, 40, which contain the recessed trough 32, each have, at the surface which faces the open channel, a planar portion 34, and a beveled portion 36. The planar portion 34 is interrupted longitudinally by the transverse recessed troughs 32. This arrangement of alternating trough 32 and planar sections 34 allows for extruded material to contact the substrate surface at the trough portions 32, while providing a flat surface in the planar portion 34 to smooth the applied material as the substrate 100 slides through the extrusion head 10. The beveled portion 36 allows for excess material to pass through the system, without being needlessly forced onto the substrate 100. This allows for easier clean-up of excess materials. During preferred operations, the flow rate of the extruded material is controlled to limit the amount of material to avoid unnecessary coverage. This, of course, will vary from application to application. The beveled portion 36 also allows further penetration of a reduced-thickness tongue into the open channel, as shown in FIG. 2. A shoulder portion 114 of the substrate 100 is engaged and held by the beveled portion 36 during the application process.

As shown, the extrusion head 10 is provided with at least one input port 60 for connecting the head to the extruder (not shown) which supplies the extrusion material. Location and number of the input ports is chosen for convenience, so long as an even flow results.

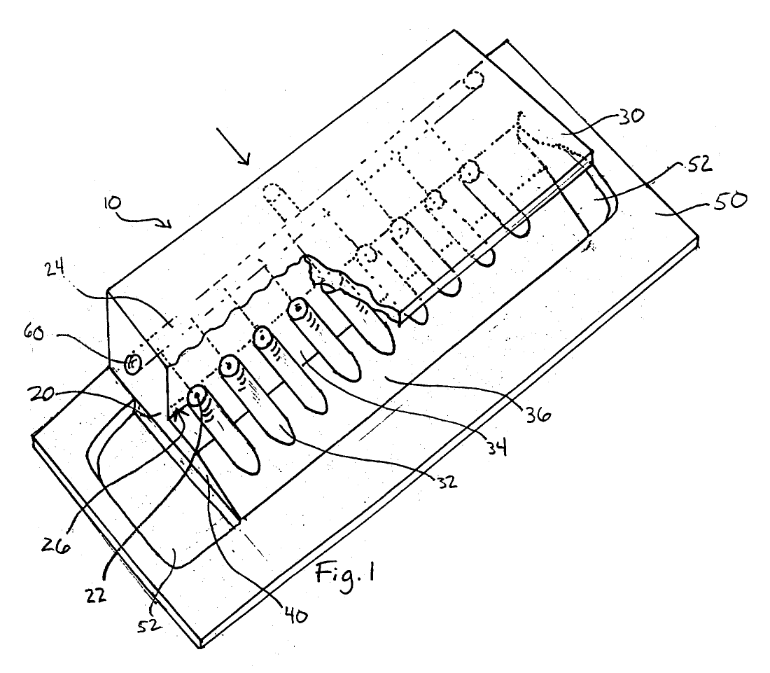

Although the extrusion head 10 may be formed by appropriate machining of a single block of material, such as aluminum, as shown FIGS. 1 and 2, other constructions are possible. In fact, a non-integral version may allow for thickness adjustability, with respect to the displacement of the upper and lower walls 30, 40. Any number of designs may be used to create a thickness adjustable embodiment of the extrusion head 10 of the invention.

A modular, plate-type construction including top and bottom plates 30a, 40a, as well as a rear wall plate 20a may be used. FIG. 4 illustrates such a system. The upper and lower walls 30a, 40a are constructed in accordance with the description above, with the exception that each is an independent plate adapted for connection to the other by an interconnecting rear-wall plate 20a. Using the plate construction, the top and/or bottom wall may be substituted by either a flat wall, without the recessed trough, or with a trough. This system allows for easy customization according to application needs. The rear wall plate 20a may be constructed with an integral manifold 24 and plurality of discharge ports 22, as discussed, at any predetermined thickness. Multiple rear-wall plates 20a, 20b of varying thickness may be kept on hand for changing as new thicknesses are required. Additionally, two or more rear-wall plates 20a, 20b may be used in conjunction with each other to achieve the desired separation of the upper and lower walls as shown in FIG. 4. In this case, each rear wall plate 20a, 20b need not be provided with a discharge port, so long as the extruded material may flow along the rear wall surface 26, while coating the substrate edge 112, into the recessed troughs 32 of the upper and lower walls 30a, 40a for distribution to the substrate surface areas 110.

Other arrangements may be used to create a thickness-adjustable extruder head according to the invention. Regardless of the arrangement, extruded material must be permitted to pass around the edge 112 of the substrate 100 in a controlled manner in order to coat at least one surface 110 of the substrate 100 adjacent to the substrate edge 112.

An additional feature shown in the figures is an overflow tray 50, which may be provided in the form of an attached plate. Assuming the extruder head 10 is aligned horizontally, an overflow tray 50 may be affixed under the lower wall 40. As shown in FIG. 1, the overflow tray 50 is provided with a recessed area 52 which accepts the extruded head 10 and provides areas on either transverse end of the extruder head in which excess extruded material may pool without contacting the substrate 100. These pooling areas 52 may further be provided with drains, for directing extruded material, before it cures, away from the extruder head 10 altogether. The invention will function without this overflow tray 50, but additional clean-up is avoided if the overflow tray 50 is used in conjunction with appropriate feed rates.

Use of the extruder head of the invention allows for quick, one-step application of adhesive materials to a substrate. Previously, manual operations required an operator to lift and turn a length of substrate while applying adhesive to the desired surfaces. Using the inventive extruder head, an operator need only place the substrate into the open channel defined by the upper, lower, and rear walls. Once in position, the substrate is slid through the channel, and the coating application completed. This operation, can be near continuous in an assembly line operation, with adhesive being applied at one station, and assembly of the various parts occurring immediately thereafter, to the extent that the cure rates of the adhesive will allow.

Another alteration of the extrusion head may involve controlling the flow of adhesive. In some systems it may be necessary to start and stop the flow of adhesive or other extruded material after each application step. This is especially true where the adhesive cures so quickly that a coated piece cannot be passed to another station or operator for joining. Instead, the extrusion operator applies the adhesive, and immediately joins the work pieces for most effective joining. In this situation, it is desirous to stop the flow of adhesive until a new piece of substrate is to be coated. Any suitable means may be used to stop the flow of extruded material, such as electric stop switches and manual valves. However, it is contemplated that the extruder head may be provided with a switch or valve which is activated only when a substrate is present. Thus, the flow would stop and start relative to placement of the substrate within the extruder head, allowing for maximum efficiency and speed during application and assembly of the various parts.

The embodiments described above are merely illustrative, and are not meant to limit the scope of the claims. The extruder head of the invention, although particularly well suited for the application of quick curing adhesives to the tongue portion of a tongue and groove fastening system, may find uses in other applications, as will be readily apparent to those skilled in the art.

What is claimed is:

1. An extruder head adapted for receiving and distributing extruded materials comprising:
a. a rear wall defining a discharge port;
b. substantially parallel upper and lower walls, wherein each of said upper and lower walls has a longitudinal axis which runs parallel to said rear wall, and are interconnected by said rear wall to define an open channel therebetween;
c. wherein at least one of said upper or lower walls defines a transverse, recessed trough aligned with said discharge port for distributing material discharged from said port;
d. wherein said open channel is adapted to receive a substrate to which extrusion material is applied when a substrate is passed through said channel.

2. The extruder head of claim 1, wherein each of said upper and lower walls is provided with a transverse, recessed trough in alignment with said discharge port.

3. The extruder head of claim 1, wherein the rear wall defines a plurality of discharge ports.

4. The extruder head of claim 3, wherein each of said upper and lower walls is provided with a plurality of recessed troughs, each aligned with one of said plurality of discharge ports.

5. The extruder head of claim 1, wherein said upper and lower walls are displaced by a predetermined amount corresponding to the thickness of the substrate.

6. The extruder head of claim 1, wherein said rear wall defines an internal distribution manifold connectable to an extruder and a plurality of discharge ports in fluid communication with said manifold for delivering extruded materials.

7. The extruder head of claim 1, wherein said upper and lower walls are adjustably displaceable with respect to one another according to desired substrate thickness.

8. The extruder head of claim 6, wherein said rear wall is defined by an outer edge of a manifold-plate defining a distribution manifold in fluid connection with a plurality of discharge ports defined by said rear wall, and each of said upper and lower walls are defined by plate like members adapted for connection to said manifold plate to define said open channel.

9. The extruder head of claim 7, wherein a plurality of said manifold plates are used to adjust the separation between said upper and lower walls to accommodate substrate thickness.

10. An extruder head adapted for receiving and distributing extruded materials comprising:
a. a rear wall defining a plurality of discharge ports;
b. substantially parallel upper and lower walls, wherein each of said upper and lower walls has a longitudinal axis which runs parallel to said rear wall, and are interconnected by said rear wall to define an open channel therebetween;
c. wherein at least one of said upper or lower walls defines a transverse, recessed trough aligned with said discharge port for distributing material discharged from said port;
d. wherein said at least one of said upper and lower walls with said trough is further defined by a substantially planar surface adjacent said rear wall, and a beveled portion extending transversely from said planar surface; wherein said planar portion is adapted for engaging a substrate, in combination with the remaining wall, said recessed trough is adapted for distributing extruded material to the surface of said substrate; and
e. wherein said open channel is adapted to receive a substrate to which extrusion material is applied when said substrate is passed through said channel.
